(19) United States
(12) Patent Application Publication
(10) Pub. No.: US 2012/0006481 A1
(43) Pub. Date: Jan. 12, 2012

(54) METHOD FOR PRODUCING METAL FOIL LAMINATE

(75) Inventors: Shohei AZAMI, Tsukuba-shi (JP); Changbo SHIM, Tsukuba-shi (JP); Toyonari ITO, Tsukuba-shi (JP)

(73) Assignee: SUMITOMO CHEMICAL COMPANY, LIMITED, Tokyo (JP)

(21) Appl. No.: 13/177,604

(22) Filed: Jul. 7, 2011

(30) Foreign Application Priority Data
Jul. 9, 2010 (JP) 2010-156363

(51) Int. Cl. C09J 5/06

(52) U.S. Cl. 156/306.6

(57) ABSTRACT

The present invention provides a method for producing a metal foil laminate, the method comprising sequentially interposing an insulating base material between a pair of metal foils and between a pair of metal plates, followed by heating and pressurizing to produce a metal foil laminate in which the pair of metal foils are attached on both sides of the insulating base material, wherein the ratio of an area of the insulating base material to that of each metal plate is from 0.75 to 0.95. According to the present invention, tight adhesion of a metal foil laminate is sufficiently increased even if the metal foil laminate has a large size.

### BACKGROUND OF THE INVENTION

1. Field of the Invention

The present invention mainly relates to a method for producing a metal foil laminate which is used as a material for a printed circuit board.

2. Description of the Related Art

Multifunctionalization of electronic equipment has acceleratively advanced year by year. Because of such multifunctionalization, in addition to an improvement in a semiconductor package which has hitherto been made, higher performances have been required in a printed circuit board on which electronic components are mounted. For example, in order to meet requirements such as miniaturization and weighting saving of electronic equipment, the necessity of densification of a printed circuit board has been increasing. Thus, multilayering of a wiring substrate, narrowing of a wiring pitch and micromiaturization of via holes has advanced.

A metal foil laminate, which is a material that has hitherto been used in this printed circuit board, has a constitution in which metal foils such as a pair of copper foils, as conductive members, are attached on both sides of an insulating base material including a thermosetting resin such as a phenol resin, an epoxy resin or a liquid crystal polyester.

When such a metal foil laminate is produced, for example, as disclosed in JP-A-2000-263577, an insulating base material is sequentially interposed between a pair of metal foils and between a pair of metal plates, followed by heating and pressurizing using a pair of upper and lower hot platens of a hot press device.

### SUMMARY OF THE INVENTION

However, according to the technique proposed in JP-A-2000-263577, the ratio of an area of an insulating base material to that of a metal plate (a value obtained by dividing an area of an insulating base material by an area of a metal plate) is small, such as about 0.5 to 0.6. Therefore, particularly when the metal foil laminate has a large size, tight adhesion of the metal foil laminate is not necessarily sufficiently, and thus the metal foil is likely to be peeled off from the insulating base material in some cases.

Under these circumstances, an object of the present invention is to provide a method for producing a metal foil laminate, which can sufficiently increase tight adhesion of a metal foil laminate even if the metal foil laminate has a large size.

In order to achieve such an object, the present inventors have found that the ratio of an area of an insulating base material to that of a metal plate is important so as to increase tight adhesion of a metal foil laminate when the insulating base material is sequentially interposed between a pair of metal foils and between a pair of metal plates, followed by heating and pressurizing, and thus the present invention has been completed.

Namely, the present invention provides a method for producing a metal foil laminate, the method comprising sequentially interposing an insulating base material between a pair of metal foils and between a pair of metal plates, followed by heating and pressurizing to produce a metal foil laminate in which the pair of metal foils are attached on both sides of the insulating base material, wherein the ratio of an area of the insulating base material to that of each metal plate is from 0.75 to 0.95.

According to the present invention, since the ratio of an area of an insulating base material to that of a metal plate is limited within a specific range, it becomes possible to sufficiently increase tight adhesion of a metal foil laminate even if the metal foil laminate has a large size.

### BRIEF DESCRIPTION OF THE DRAWINGS

FIG. 1 is a view showing a metal foil laminate according to First Embodiment of the present invention, in which FIG. 1A is a perspective view thereof and FIG. 1B is a sectional view thereof;

FIG. 2 is a sectional view showing a method for producing the metal foil laminate according to First Embodiment;

FIG. 3 is a schematic block diagram of a hot press device according to First Embodiment; and

FIG. 4 is a sectional view showing a method for producing a metal foil laminate according to Second Embodiment of the present invention.

### DETAILED DESCRIPTION OF THE INVENTION

Embodiments of the present invention will be described below.

### First Embodiment of the Invention

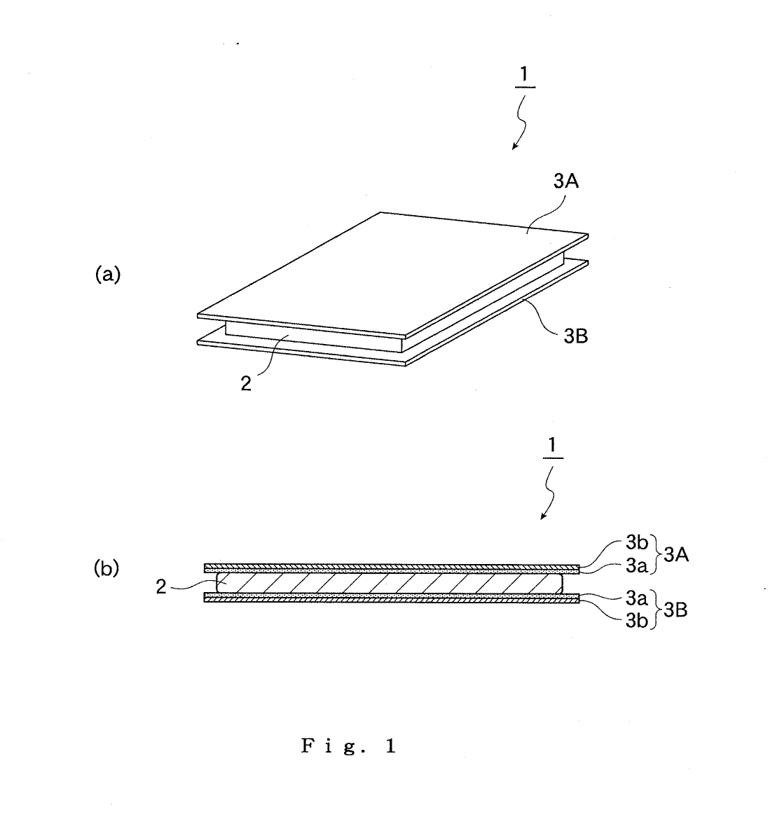

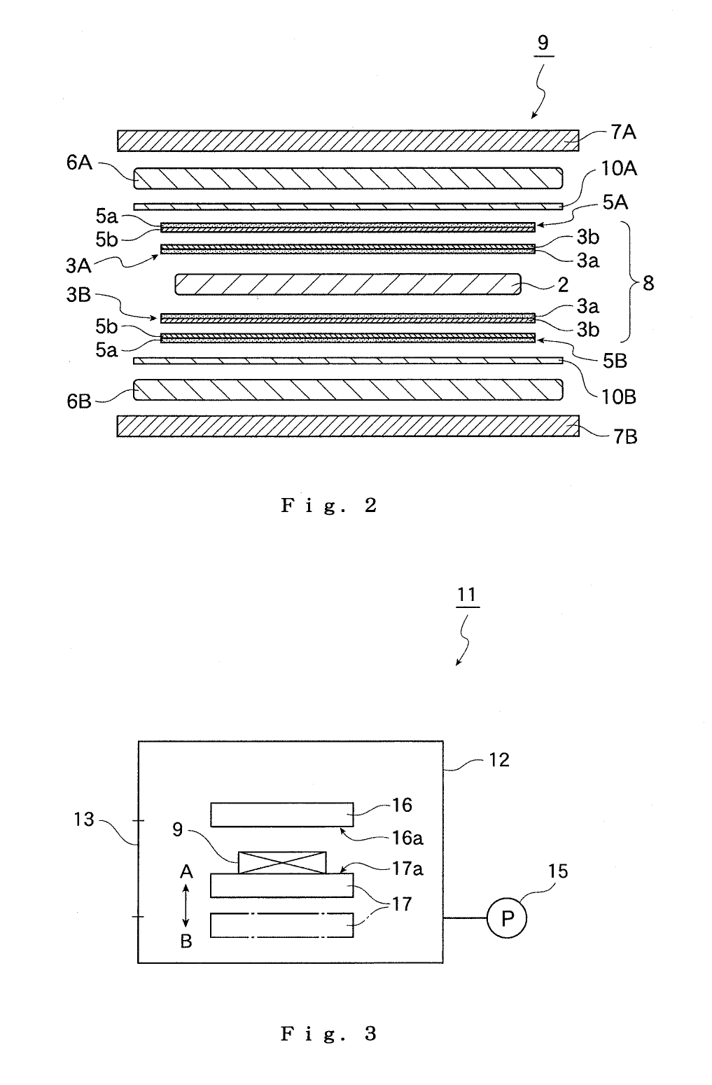

In FIG. 1 to FIG. 3, First Embodiment of the present invention is shown. In First Embodiment, one-stage configuration, namely, the case where one metal foil laminate is produced by single hot pressing will be described. In FIG. 2, the respective members are shown in a state of being separated from each other for easy understanding.

As shown in FIG. 1, a metal foil laminate 1 according to First Embodiment includes a square plate-shaped resin-impregnated base material 2 and square sheet-shaped copper foils 3 (3A, 3B) are integrally attached on both upper and lower surfaces of the resin-impregnated base material 2, respectively. Herein, as shown in FIG. 1B, each copper foil 3 has a two-layered structure including a matted surface 3a and a shine surface 3b, and is contacted with the resin-impregnated base material 2 at the side of the matted surface 3a. The size (one side of a square) of each copper foil 3 is slightly larger than that of the resin-impregnated base material 2. In order to obtain a metal foil laminate 1 having satisfactory surface smoothness, it is desirable that each copper foil 3 has a thickness of 18 μm or more and 100 μm or less, from the viewpoint of ease of availability and ease of handling.

Herein, the resin-impregnated base material 2 is a prepreg in which an inorganic fiber (preferably, a glass cloth) or a carbon fiber is impregnated with a liquid crystal polyester which is excellent in heat resistance and electrical characteristics. This liquid crystal polyester is a polyester having characteristics in which optical anisotropy is exhibited upon melting and an anisotropic melt is formed at a temperature of 450° C. or lower. The liquid crystal polyester used in the present invention is preferably a liquid crystal polyester which includes a structural unit represented by the formula (1) shown below (hereinafter referred to as “structural unit of the formula (1)”), a structural unit represented by the formula (2) shown below (hereinafter referred to as “structural unit of the formula (2)”) and a structural unit represented by the formula (3) shown below (hereinafter referred to as “structural unit of the formula (3)”), wherein the content of the structural unit of the formula (1) is from 30 to 45 mol %, the content of the structural unit of the formula (2) is from 27.5 to 35 mol %, and the content of the structural unit of the formula (3) is from 27.5 to 35 mol %, based on the total content (mass of each structural unit constituting a liquid crystal polyester is divided by the formula weight of each structural unit to determine the content of each structural unit as an amount (mol) corresponding to a substance amount, and then the total content is determined by totaling the contents of the respective structural units) of all structural units:

—O—Ar¹—CO—, (1)

—CO—Ar²—CO—, (2)

—X—Ar³—Y— (3)

wherein Ar¹ represents a phenylene group or a naphthylene group, Ar² represents a phenylene group, a naphthylene group or a group represented by the formula (4) shown below, Ar³ represents a phenylene group or a group represented by the formula (4) shown below, X and Y each independently represent O or NH, and hydrogen atoms, existing in the group represented by Ar¹, Ar² or Ar³, each independently may be substituted with a halogen atom, an alkyl group or an aryl group, and

—Ar¹¹—Z—Ar¹² (4)

wherein Ar¹¹ and Ar¹² each independently represent a phenylene group or a naphthylene group, and Z represents O, CO or SO₂.

The structural unit of the formula (1) is a structural unit derived from an aromatic hydroxycarboxylic acid, and examples of this aromatic hydroxycarboxylic acid include p-hydroxybenzoic acid, m-hydroxybenzoic acid, 2-hydroxy-6-naphthoic acid, 2-hydroxy-3-naphthoic acid, 1-hydroxy-4-naphthoic acid and the like.

The structural unit of the formula (2) is a structural unit derived from an aromatic dicarboxylic acid, and examples of this aromatic dicarboxylic acid include terephthalic acid, isophthalic acid, 2,6-naphthalenedicarboxylic acid, 1,5-naphthalenedicarboxylic acid, diphenylether-4,4′-dicarboxylic acid, diphenylsulfone-4,4′-dicarboxylic acid, diphenylketone-4,4′-dicarboxylic acid and the like.

The structural unit of the formula (3) is a structural unit derived from an aromatic diol, an aromatic amine having a phenolic hydroxyl group (phenolic hydroxyl group) or an aromatic diamine. Examples of this aromatic diol include hydroquinone, resorcin, 2,2-bis(4-hydroxy-3,5-dimethylphenyl)propane, bis(4-hydroxyphenyl)ether, bis-(4-hydroxyphenyl)ketone, bis-(4-hydroxyphenyl)sulfone and the like.

Examples of this aromatic amine having a phenolic hydroxyl group include 4-aminophenol (p-aminophenol), 3-aminophenol (m-aminophenol) and the like, and examples of this aromatic diamine include 1,4-phenylenediamine, 1,3-phenylenediamine and the like.

The liquid crystal polyester used in the present invention is soluble in a solvent, and the solubility in a solvent means that it is soluble in a solvent in the concentration of 1% by mass or more at a temperature of 50° C. In this case, the solvent is any one kind of suitable solvents used in the preparation of a liquid composition described hereinafter and the details are described hereinafter.

The liquid crystal polyester having solubility in a solvent is preferably a liquid crystal polyester which includes, as the structural unit of the formula (3), a structural unit derived from an aromatic amine having a phenolic hydroxyl group and/or a structural unit derived from an aromatic diamine. That is, it is preferred to include, as the structural unit of the formula (3), a structural unit in which at least one of X and Y is NH (a structural unit represented by the formula (3′), hereinafter referred to as “structural unit of the formula (3′)”) since the obtained liquid crystal polyester may have excellent solubility in a suitable solvent described hereinafter (aprotic polar solvent). It is particularly preferred that substantially all structural units of the formula (3) are structural units of the formula (3′). This structural unit of the formula (3′) is advantageous in the point that sufficient solubility in a solvent of the liquid crystal polyester is ensured and also low water absorptivity of the liquid crystal polyester increases:

—X—Ar³—NH— (3′)

wherein Ar³ and X have the same meaning as defined above.

It is more preferred to include the structural unit of the formula (3) in the proportion within a range from 30 to 32.5 mol % based on the total content of all structural units, whereby, solubility in a solvent becomes more satisfactory. As described above, the liquid crystal polyester including the structural unit of the formula (3′) as the structural unit of the formula (3) also has an advantage that it becomes more easy to produce the resin-impregnated base material 2 using a liquid composition described hereinafter, in addition to the points of solubility in a solvent and low water absorptivity.

It is preferred to include the structural unit of the formula (1) in the proportion within a range from 30 to 45 mol %, and more preferably from 35 to 40 mol %, based on the total content of all structural units. The liquid crystal polyester including the structural unit of the formula (1) in such a molar fraction may tend to be more excellent in solubility in a solvent while sufficiently maintaining mesomorphism. Also, considering together availability of the aromatic hydroxycarboxylic acid, from which the structural unit of the formula (1) is derived, p-hydroxybenzoic acid and/or 2-hydroxy-6-naphthoic acid are suitable as this aromatic hydroxycarboxylic acid.

It is preferred to include the structural unit of the formula (2) in the proportion within a range from 27.5 to 35 mol %, and more preferably from 30 to 32.5 mol %, based on the total content of all structural units. The liquid crystal polyester including the structural unit of the formula (2) in such a molar fraction may tend to be more excellent in solubility in a solvent while sufficiently maintaining mesomorphism. Also, considering together availability of the aromatic dicarboxylic acid, from which the structural unit of the formula (2) is derived, it is preferably at least one kind selected from the group consisting of terephthalic acid, isophthalic acid and 2,6-naphthalenedicarboxylic acid as this aromatic dicarboxylic acid.

From the viewpoint of higher-level mesomorphism exhibited by the obtained liquid crystal ester, the molar fraction of the structural unit of the formula (2) to the structural unit of the formula (3), namely, [structural unit of the formula (2)]/[structural unit of the formula (3)] is suitably within a range from 0.9/1 to 1/0.9.

A method for producing a liquid crystal polyester will be briefly described below.

This liquid crystal polyester can be produced by various known methods. When a suitable liquid crystal polyester, namely, a liquid crystal polyester including a structural unit of the formula (1), a structural unit of the formula (2) and a structural unit of the formula (3) is produced, a method of producing a liquid crystal polyester by converting a monomer, from which these structural units are derived, into an ester- and amide-forming derivative, and then polymerizing the ester- and amide-forming derivative is preferred since an operation thereof is simple.

This ester- and amide-forming derivative will be described by way of examples.

Examples of the ester- and amide-forming derivative of a monomer having a carboxyl group such as an aromatic hydroxycarboxylic acid or an aromatic dicarboxylic acid include those in which the carboxyl group is a group having high reaction activity such as a acid chloride or an acid anhydride so as to promote a reaction of producing polyester or polyamide, those in which the carboxyl group forms an ester with alcohols, ethylene glycol or the like so as to produce polyester or polyamide by an ester- and amide-interchange reaction.

Examples of the ester- and amide-forming derivative of a monomer having a phenolic hydroxyl group such as an aromatic hydroxycarboxylic acid or an aromatic diol include those in which a phenolic hydroxyl group forms an ester with carboxylic acids so as to produce polyester or polyamide by an ester-interchange reaction.

Examples of the amide-forming derivative of a monomer having an amino group such as an aromatic diamine include those in which an amino group forms an amide with carboxylic acids so as to produce polyamide by an amide-interchange reaction.

Among these, a method of producing a liquid crystal polyester by acylating an aromatic hydroxycarboxylic acid, and a monomer having a phenolic hydroxyl group and/or an amino group such as an aromatic diol, an aromatic amine having a phenolic hydroxyl group or an aromatic diamine using a fatty acid anhydride to obtain an ester- and amide-forming derivative (acylate), and then polymerizing the ester- and amide-forming derivative so that an acyl group of the acrylate and a carboxyl group of a monomer having a carboxyl group undergoes an ester- and amide-interchange is particularly preferred so as to produce a liquid crystal polyester more easily and simply.

Such a method of producing a liquid crystal polyester is disclosed, for example, in JP-A-2002-220444 or JP-A-2002-146003.

In the acylation, the additive amount of a fatty acid anhydride is preferably from 1- to 1.2-fold equivalent, and more preferably from 1.05- to 1.1-fold equivalent, based on the total amount of a phenolic hydroxyl group and an amino group. When the additive amount of a fatty acid anhydride is less than 1-fold equivalent, the acrylate and the raw monomer undergo sublimation upon polymerization and thus the reaction system may tend to cause clogging. In contrast, when the additive amount of a fatty acid anhydride is more than 1.2-fold equivalent, the obtained liquid crystal polyester may be drastically colored.

The acylation is preferably carried out at 130 to 180° C. for 5 minutes to 10 hours, and more preferably at 140 to 160° C. for 10 minutes to 3 hours.

From the viewpoint of cost and handling properties, the fatty acid anhydride used in acylation is preferably acetic anhydride, propionic anhydride, butyric anhydride, isobutyric anhydride or a mixture of two or more kinds selected therefrom, and particularly preferably acetic anhydride.

Polymerization which follows acylation is preferably carried out while temperature rising within a range from 130 to 400° C. at a rate of 0.1 to 50° C./minute, and more preferably within a range from 150 to 350° C. at a rate of 0.3 to 5° C./minute.

In the polymerization, the amount of the acyl group of an acrylate is preferably 0.8 to 1.2-fold equivalent based on the carboxyl group.

In case of the acylation and/or polymerization, a fatty acid and an unreacted fatty acid anhydride produced as by-products are preferably distilled out of the system by vaporization or the like so as to carry out equilibrium displacement by Le Chatelier-Braun principle (principle of equilibrium displacement).

The acylation and polymerization may be carried out in the presence of a catalyst. It is possible to use, as the catalyst, those which have hitherto been known as a catalyst for polymerization of polyester, and examples thereof include metal salt catalysts such as magnesium acetate, stannous acetate, tetrabutyl titanate, lead acetate, sodium acetate, potassium acetate and antimony trioxide; and organic compound catalysts such as N,N-dimethylaminopyridine and N-methylimidazole.

Among these catalysts, a heterocyclic compound containing two or more nitrogen atoms, such as N,N-dimethylaminopyridine or N-methylimidazole is preferably used (see JP-A-2002-146003).

Usually, this catalyst is simultaneously charged when a monomer is charged and it is not necessarily required to remove after the acylation. When this catalyst is not removed, the acylation can be shifted to the polymerization as it is.

The liquid crystal polyester obtained in such polymerization can be used as it is in the present invention. In order to further improve characteristics such as heat resistance and mesomorphism, the molecular weight is preferably increased and solid phase polymerization is preferably carried out so as to achieve an increase in molecular weight. A series of operations according to this solid phase polymerization will be described below. The liquid crystal polyester having comparatively low molecular weight obtained by the above polymerization is taken out and ground into a powder or flake. Subsequently, for example, the liquid crystal polyester after grinding is subjected to a heat treatment under an atmosphere of an inert gas such as nitrogen at 20 to 350° C. for 1 to 30 hours in a solid state. The solid phase polymerization can be carried out by these operations. This solid phase polymerization may be carried out while stirring, or may be carried out in a state of being left to stand without stirring. From the viewpoint of obtaining a liquid crystal polyester having a suitable flow initiation temperature described hereinafter, when suitable conditions of this solid phase polymerization are described in detail, the reaction temperature is preferably higher than 210° C., and more preferably within a range from 220 to 350° C. The reaction time is preferably selected from 1 to 10 hours.

In the liquid crystal polyester used in the present invention, the flow initiation temperature is preferably 250° C. or higher in the point that higher tight adhesion is obtained between a conductor layer formed on the resin-impregnated base material 2 and an insulating layer (resin-impregnated base material 2). As used herein, the flow initiation temperature refers to a temperature at which melt viscosity of a liquid crystal polyester becomes 4,800 Pa·s or less under a pressure of 9.8 MPa in the evaluation of melt viscosity using a flow tester. This flow initiation temperature is well known to a person with an ordinary skill in the art as an indication of the molecular weight of the liquid crystal polyester (see, for example, edited by Naoyuki Koide, “Synthesis, Forming and Application of Liquid Crystal Polymer”, pp. 95-105, CMC, issued on Jun. 5, 1987).

This flow initiation temperature of the liquid crystal polyester is more preferably 250° C. or higher and 300° C. or lower. When the flow initiation temperature is 300° C. or lower, the solubility in a solvent of the liquid crystal polyester becomes more satisfactory, and also the viscosity does not remarkably increase when a liquid to composition described hereinafter is obtained. Therefore, the handling properties of this liquid composition may tend to become satisfactory. From such a point of view, a liquid crystal polyester having a flow initiation temperature of 260° C. or higher and 290° C. or lower is more preferred. In order to control the flow initiation temperature of the liquid crystal polyester within such a suitable range, polymerization conditions of the solid phase polymerization may be appropriately optimized.

The resin-impregnated base material 2 is particularly preferably a resin-impregnated base material obtained by impregnating an inorganic fiber (preferably, a glass cloth) or a carbon fiber with a liquid composition containing a liquid crystal polyester and a solvent (particularly a liquid composition prepared by dissolving a liquid crystal polyester in a solvent), and then drying to remove the solvent. The amount of the liquid crystal polyester, which adheres to the resin-impregnated base material 2 after removal of the solvent, is preferably from 30 to 80% by mass, and more preferably 40 to 70% by mass, based on the mass of the obtained resin-impregnated base material 2.

When the aforementioned suitable liquid crystal polyester, particularly a liquid crystal polyester including the aforementioned structural unit of the formula (3′) is used as the liquid crystal polyester used in the present invention, this liquid crystal polyester exhibits sufficient solubility in an aprotic solvent containing no halogen atom.

Herein, examples of the aprotic solvent containing no halogen atom include ether-based solvents such as diethylether, tetrahydrofuran and 1,4-dioxane; ketone-based solvents such as acetone and cyclohexanone; ester-based solvents such as ethyl acetate; lactone-based solvents such as γ-butyrolactone; carbonate-based solvents such as ethylene carbonate and propylene carbonate; amine-based solvents such as triethylamine and pyridine; nitrile-based solvents such as acetonitrile and succinonitrile; amide-based solvents such as N,N-dimethylformamide, N,N-dimethylacetamide, tetramethylurea and N-methyl pyrrolidone; nitro-based solvents such as nitromethane and nitrobenzene; sulfur-based solvents such as dimethyl sulfoxide and sulfolane; and phosphorous-based solvents such as hexamethylphosphoric acid amide and tri-n-butylphosphoric acid. The aforementioned solubility in a solvent of the liquid crystal polyester refers to solubility in at least one aprotic solvent selected from these solvents.

From the viewpoint of easily obtaining a liquid composition by making solubility in a solvent of the liquid crystal polyester more satisfactory, it is preferred to use an aprotic polar solvent having a dipole moment of 3 or more and 5 or less among the exemplified solvents. Specifically, it is preferred to use an amide-based solvent and a lactone-based solvent, and more preferably N,N-dimethylformamide (DMF), N,N-dimethylacetamide (DMAc) and N-methylpyrrolidone (NMP). Furthermore, when the solvent is a high volatility solvent having a boiling point of 180° C. or lower at 1 atm, there is an advantage that it is easy to remove the solvent after impregnating the sheet with a liquid composition. From this point of view, DMF and DMAc are particularly preferred. Use of such an amide-based solvent also has an advantage that, since thickness unevenness or the like is less likely to arise in the production of the resin-impregnated base material 2, it is easy to form a conductor layer on this resin-impregnated base material 2.

When the above aprotic solvent is used as the liquid composition, a liquid crystal polyester is preferably dissolved in an amount of 20 to 50 parts by mass, and more preferably 22 to 40 parts by mass, based on 100 parts by mass of this aprotic solvent. When the content of the liquid crystal polyester in this liquid composition is within the above range, efficiency of impregnating the sheet with the liquid composition becomes satisfactory in the production of the resin-impregnated base material 2, and thus there is a tendency of arising a disadvantage with difficulty that thickness unevenness or the like arises when the solvent is removed by drying after impregnation.

As long as the object of the present invention is not impaired, it is possible to add one or two or more kinds of resin(s) other than the liquid crystal polyester, for example, thermoplastic resins such as polypropylene, polyamide, polyester, polyphenylene sulfide, polyetherketone, polycarbonate, polyethersulfone, polyphenylether and a modified substance thereof, and polyetherimide; elastomers typified by a copolymer of glycidyl methacrylate and polyethylene; thermosetting resins such as a phenol resin, an epoxy resin, a polyimide resin and a cyanate resin; to the liquid composition. Also even when such other resins are used, the other resins are also preferably soluble in this solvent used in the liquid composition.

Furthermore, as long as the effects of the present invention are not impaired, it is possible to add one or two or more kinds of various additives, for example, inorganic fillers of silica, alumina, titanium oxide, barium titanate, strontium titanate, aluminum hydroxide, calcium carbonate and the like; organic fillers of a cured epoxy resin, a crosslinked benzoguanamine resin, a crosslinked acrylic polymer and the like; silane coupling agents, antioxidants, ultraviolet absorbers and the like; to this liquid composition for the purpose of improving such as dimensional stability, pyroconductivity and electrical characteristics.

In this liquid composition, fine foreign matters contained in the solution may be optionally removed by a filtration treatment using a filter or the like.

Furthermore, this liquid composition may be optionally subjected to a degassing treatment.

The base material to be impregnated with the liquid crystal polyester used in the present invention includes an inorganic fiber and/or a carbon fiber. Herein, the inorganic fiber is a ceramic fiber typified by glass, and examples thereof include a glass fiber, an alumina-based fiber, a silicon-containing ceramic-based fiber and the like. Among these inorganic fibers, a sheet mainly including a glass fiber, namely, a glass cloth is preferred because of large mechanical strength and satisfactory availability.

The glass cloth is preferably a glass cloth including an alkali-containing glass fiber, a non-alkali glass fiber or a low dielectric glass fiber. It is also possible to partially mix, as the fiber constituting the glass cloth, a ceramic fiber including ceramic other than glass or a carbon fiber. The fiber constituting the glass cloth may be surface-treated with a coupling agent such as an aminosilane-based coupling agent, an epoxysilane-based coupling agent or a titanate-based coupling agent.

Examples of a method of producing a glass cloth including these fibers include a method in which fibers constituting a glass cloth are dispersed in water and a sizing agent such as an acrylic resin is optionally added and, followed by sheet making using a paper machine and further drying to obtain a nonwoven fabric, and a method using a known weaving machine.

It is possible to weave fibers using a plain weaving method, a satin weaving method, a twill weaving method, a mat weaving method and the like. A glass cloth having a weave density of 10 to 100 fibers/25 mm and a mass per unit area of the glass cloth of 10 to 300 g/m² is preferably used. The thickness of the glass cloth to be used is usually from about 10 to 200 μm, and more preferably from 10 to 180 μm.

It is also possible to use a glass cloth which is easily available from the market. As such a glass cloth, various products are commercially available as an insulating impregnated base material of electronic components and are available from Asahi-Schwebel Co., Ltd., Nitto Boseki Co., Ltd., Arisawa Manufacturing Co., Ltd. and the like. Examples of the commercially available glass cloth having a suitable thickness include those having IPC names of 1035, 1078, 2116 and 7628.

The glass cloth suited as an inorganic fiber can be typically impregnated with a liquid composition by preparing a dipping bath in which this liquid composition is charged, and dipping the glass cloth in this dipping bath. Herein, when the content of the liquid crystal polyester in the liquid composition used, the time of dipping in the dipping bath, and the pull-up rate of the glass cloth impregnated with the liquid composition are appropriately optimized, the adhesion amount of the aforementioned suitable liquid crystal polyester can be easily controlled.

The resin-impregnated base material 2 can be produced by removing the solvent from the glass cloth thus impregnated with the liquid composition. There is no particular limitation on a method of removing the solvent, and vaporization of the solvent is preferred from the viewpoint of a simple operation, and a heating method, an evacuation method, a ventilation method or a method of a combination thereof is used. In the production of the resin-impregnated base material 2, a heat treatment is further carried out after removing the solvent. By such a heat treatment, it is possible to increase the molecular weight of the liquid crystal polyester contained in the zo resin-impregnated base material 2 after removal of the solvent. With respect to the treatment conditions according to this heat treatment, for example, a heat treatment is carried out under an atmosphere of an inert gas such as nitrogen at 240 to 330° C. for 1 to 30 hours. From the viewpoint of obtaining a metal foil laminate having more satisfactory heat resistance, with respect to the treatment conditions of this heat treatment, the heating temperature is preferably higher than 250° C., and more preferably within a range from 260 to 320° C. It is preferred in view of productivity that the treatment time of this heat treatment is selected from 1 to 10 hours.

As shown in FIG. 3, a hot press device 11 for producing a metal foil laminate 1 described above includes a rectangular solid chamber 12, and a door 13 is attached on the side (left side in FIG. 3) of the chamber 12 in an openable/closable manner. To the chamber 12, a vacuum pump 15 is connected so that the interior of the chamber 12 is reduced to predetermined pressure (preferably, pressure of 2 kPa or less). Furthermore, in the chamber 12, a pair of upper and lower hot platens (an upper hot platen 16 and a lower hot platen 17) are disposed opposite each other. Herein, the upper hot platen 16 is fixed to the chamber 12 so as not to ascend/descend, while the lower hot platen 17 is disposed in ascendable/decendable manner in the so direction of arrow A-B to the upper hot platen 16. A pressure surface 16a is formed on the lower surface of the upper hot platen 16, while a pressure surface 17a is formed on the upper surface of the lower hot platen 17.

The metal foil laminate 1 is produced by the following procedure using this hot press device 11.

In a first laminate production process described hereinafter, as shown in FIG. 2, a pair of upper and lower square sheet-shaped spacer copper foils 5 (5A, 5B) are used. Each spacer copper foil 5 has a two-layered structure including a matted surface 5a and a shine surface 5b.

In a second laminate production process described hereinafter, a pair of upper and lower square sheet-shaped SUS plates 10 (10A, 10B), a pair of upper and lower square sheet-shaped SUS plates 6 (6A, 6B), and a pair of upper and lower square sheet-shaped aramid cushions 7 (7A, 7B) are used. Herein, as the size of each SUS plate 10, the size which is slightly larger than that of the resin-impregnated base material 2 is employed so that the ratio of an area of the resin-impregnated base material 2 to that of the SUS plate 10 falls within a range from 0.75 to 0.95 (preferably from 0.85 to 0.95). When this area ratio is less than 0.75, in a second laminate heating/pressurizing step described hereinafter, the pressure from the upper hot platen 16 and the lower hot platen 17 are not properly transferred to the resin-impregnated base material 2, and thus tight adhesion between the resin-impregnated base material 2 and each copper foil 3 may become insufficient. In contrast, when this area ratio is more than 0.95, in the second laminate heating/pressurizing step described hereinafter, there arises no problem in tight adhesion between the resin-impregnated base material 2 and each copper foil 3. However, there is a disadvantage that the resin flows out from the peripheral portion of the resin-impregnated base material 2 to cause contamination of the SUS plate 10B, the aramid cushion 7B and the lower hot platen 17.

First, in the first laminate production process, as shown in FIG. 2, the resin-impregnated base material 2 is sequentially interposed between a pair of copper foils 3A, 3B and between a pair of spacer copper foils 5A, 5B to fabricate a first laminate 8.

For that purpose, first, the resin-impregnated base material 2 is interposed between two copper foils 3A, 3B. At this time, the matted surface 3a of each copper foil 3 is allowed to face toward the inside (the side of resin-impregnated base material 2). Then, these copper foils 3A, 3B are interposed between two spacer copper foils 5A, 5B. At this time, the shine surface 5b of each spacer copper foil 5 is allowed to face toward the inside (the side of copper foil 3). Thus, the first laminate 8 including the to resin-impregnated base material 2, the pair of copper foils 3A, 3B, and the pair of spacer copper foils 5A, 5B is obtained.

The first laminate 8 thus obtained is shifted to the second laminate production process and, as shown in FIG. 2, the first laminate 8 is sequentially interposed between a pair of SUS plates 10A, 10B, between a pair of SUS plates 6A, 6B, and between a pair of aramid cushions 7A, 7B to fabricate a second laminate 9.

For that purpose, the first laminate 8 is interposed between two SUS plates 10A, 10B. After interposing these SUS plates 10A, 10B between two SUS plates 6A, 6B, these SUS plates 6A, 6B are interposed between two aramid cushions 7A, 7B. Thus, the second laminate 9 including the first laminate 8, the pair of SUS plates 10A, 10B, the pair of SUS plates 6A, 6B, and the pair of aramid cushions 7A, 7B is obtained.

At this time, since the aramid cushion 7 is excellent in handling properties, an operation of fabricating the second laminate 9 can be carried out easily and quickly.

The second laminate 9 thus obtained is shifted to the second laminate heating/pressurizing step, and the second laminate 9 is heated and pressurized in the lamination direction thereof (vertical direction in FIG. 2) by the upper hot platen 16 and the lower hot platen 17.

That is, as shown in FIG. 3, first, the door 13 is opened and the second laminate 9 is disposed on the pressure surface 17a of the lower hot platen 17. Then, the door 13 is closed and the vacuum pump 15 is operated, thereby reducing the pressure in the chamber 12 to predetermined pressure. In this state, the lower hot platen 17 is appropriately ascended in the direction of arrow A, whereby, the second laminate 9 is fixed by softly interposing between the upper hot platen 16 and the lower hot platen 17. Next, the temperature of the upper hot platen 16 and the lower hot platen 17 is raised. After the temperature is raised to a predetermined temperature, the second laminate 9 is heated and pressurized between the upper hot platen 16 and the lower hot platen 17 by further ascending the lower hot platen 17 in the direction of arrow A. Thus, the metal foil laminate 1 is formed between the upper hot platen 16 and the lower hot platen 17.

At this time, as aforementioned above, the size of each SUS plate 10 is slightly larger than that of the resin-impregnated base material 2 (specifically, the ratio of an area of the resin-impregnated base material 2 to that of the SUS plate 10 is from 0.75 to 0.95). Therefore, even if the metal foil laminate 1 has a large size, tight adhesion of the metal foil laminate 1 can be sufficiently increased. Moreover, in the first laminate 8, the matted surface 3a of each copper foil 3 is contacted with the resin-impregnated base material 2, and thus the pair of copper foils 3A, 3B are strongly fixed to the resin-impregnated base material 2 by an anchor effect. Accordingly, it becomes possible to drastically suppress each copper foil 3 from peeling off from the resin-impregnated base material 2 after formation of the metal foil laminate 1, and thus a commercial value as the metal foil laminate 1 can be increased.

With respect to the conditions of the heating/pressurizing treatment in this second laminate heating/pressurizing step, it is preferred to appropriately optimize the treatment temperature and treatment pressure so that the obtained laminate exhibits satisfactory surface smoothness. This treatment temperature can be based on the temperature conditions of the heat treatment used when the resin-impregnated base material 2 used in hot pressing is produced. Specifically, assumed that Tₘₐₓ [° C.] denotes the maximum temperature of temperature conditions according to the heat treatment used when the resin-impregnated base material 2 is produced, hot pressing is preferably carried out at a temperature which is higher than this Tₘₐₓ, and more preferably a temperature of Tₘₐₓ+5[° C.] or higher. The upper limit of the temperature according to this hot pressing can be selected so that it is lower than the decomposition temperature of the liquid crystal polyester contained in the resin-impregnated base material 2 used, and is preferably adjusted to a temperature which is 30° C. or higher lower than this composition temperature. As used herein, the decomposition temperature is determined by a known means such as thermogravimetric analysis. The treatment time of this hot pressing is preferably selected from 10 minutes to 5 hours, and the press pressure is preferably selected from 1 to 30 MPa.

After the lapse of a predetermined time while maintaining this pressurized state, the temperature of the upper hot platen 16 and the lower hot platen 17 is lowered while maintaining the pressurized state of the second laminate 9. Thereafter, when the temperature is lowered to a predetermined temperature, the lower hot platen 17 is appropriately descended in the direction of arrow B, resulting in a state where the second laminate 9 is softly interposed between the upper hot platen 16 and the lower hot platen 17. Then, the evacuated state in the chamber 12 is released and also the lower hot platen 17 is further descended in the direction of arrow B, thereby separating the second laminate 9 from the pressure surface 16a of the upper hot platen 16. Finally, the door 13 is opened and the second laminate 9 is taken out from the interior of the chamber 12.

After the second laminate 9 is taken out, the metal foil laminate 1 is separated from this second laminate 9. At this time, since the shine surface 3b of each copper foil 3 is contacted with the shine surface 5b of each spacer copper foil 5, each spacer copper foil 5 can be easily peeled off from each copper foil 3.

Herein, the production procedure of the metal foil laminate 1 is completed, and the metal foil laminate 1 is obtained.

### Second Embodiment of the Invention

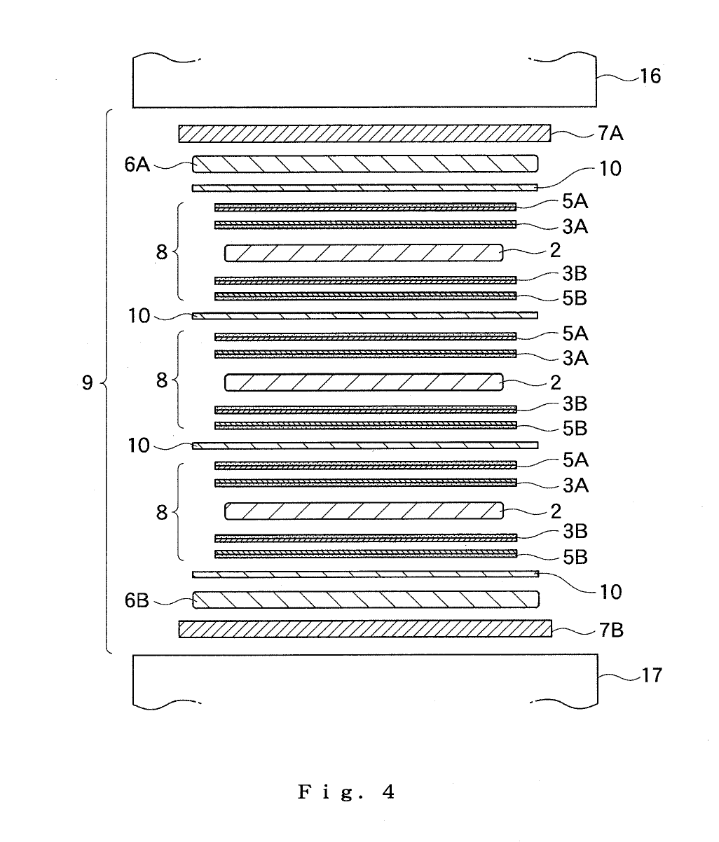

In FIG. 4, Second Embodiment of the present invention is shown. In Second Embodiment, three-stage configuration, namely, the case of producing three metal foil laminates by single hot pressing will be described. In FIG. 4, the respective members are shown in a state of being separated from each other for easy understanding.

The metal foil laminate 1 and the hot press device 11 according to Second Embodiment have the same constitution as that of First Embodiment.

When the metal foil laminate 1 is produced using this hot press device 11, three metal foil laminates 1 are simultaneously produced in accordance with the production procedure of the metal foil laminate 1 in First Embodiment, as described hereinafter.

First, in the first laminate production process, in the same manner as in First Embodiment, the resin-impregnated base material 2 is sequentially interposed between a pair of copper foils 3A, 3B and between a pair of spacer copper foils 5A, 5B to fabricate three first laminates 8, as shown in FIG. 4.

Next, three first laminates 8 are shifted to the second laminate production process, as shown in FIG. 4, and these three first laminates 8 are laid one upon another in the lamination direction thereof (vertical direction in FIG. 4) via four SUS plates 10 to fabricate a second laminate 9 in which three first laminates sequentially interposed between a pair of SUS plates 6A, 6B and between a pair of aramid cushions 7A, 7B. Herein, as each SUS plate 10, a SUS plate having a size, which is slightly larger than that of the resin-impregnated base material 2 (the ratio of an area of the resin-impregnated base material 2 to that of the SUS plate 10 falls within a range from 0.75 to 0.95 (preferably from 0.85 to 0.95)) is employed in the same manner as in First Embodiment.

Finally, the second laminate thus obtained is shifted to the second laminate heating/pressurizing step, and the second laminate 9 is heated and pressurized in the lamination direction thereof (vertical direction in FIG. 4) by the upper hot platen 16 and the lower hot platen 17 in the same manner as in First Embodiment, as shown in FIG. 4. Thus, three metal foil laminates 1 are simultaneously formed between the upper hot platen 16 and the lower hot platen 17.

At this time, the size of each SUS plate 10 is slightly larger than that of the resin-impregnated base material 2 (specifically, the ratio of an area of the resin-impregnated base material 2 to that of the SUS plate 10 is from 0.75 to 0.95) as aforementioned above. Therefore, even if the three metal foil laminates 1 have a large size, tight adhesion of each metal foil laminate 1 can be sufficiently increased. Moreover, in each first laminate 8, the matted surface 3a of each copper foil 3 is contacted with the resin-impregnated base material 2, and thus the pair of copper foils 3A, 3B are strongly fixed to the resin-impregnated base material 2 by an anchor effect. Accordingly, it becomes possible to drastically suppress each copper foil 3 from peeling off from the resin-impregnated base material 2 after formation of three metal foil laminates 1, and thus a commercial value as the metal foil laminate 1 can be increased.

In the same manner as in First Embodiment, the second laminate 9 is taken out from the interior of the chamber 12 and three metal foil laminates 1 are separated from this second laminate 9. At this time, since the shine surface 3b of each copper foil 3 is contacted with the shine surface 5b of each spacer copper foil 5, each spacer copper foil 5 can be easily peeled off from each copper foil 3.

Herein, the production procedure of the metal foil laminate 1 is completed, and thus three metal foil laminates 1 are obtained.

### Other Embodiments of the Invention

While the case of using the resin-impregnated base material 2 as the insulating base material was described in First and Second Embodiments, an insulating base material other than the resin-impregnated base material 2 (for example, a resin film such as a liquid crystal polyester film or a polyimide film) can also be substituted for the resin-impregnated base material or used in combination with the resin-impregnated base material.

While the case of using the copper foil 3 as the metal foil was described in First and Second Embodiments, a metal foil other than the copper foil 3 (for example, a SUS foil, a gold foil, a silver foil, a nickel foil, an aluminum foil, etc.) can also be substituted for the copper foil or used in combination with the copper foil.

While the case of using the SUS plate 10 as the metal plate was described in First and Second Embodiments, a metal plate other than the SUS plate 10 (for example, an aluminum plate, etc.) can also be substituted for the SUS plate or used in combination with the SUS plate.

While the case of using, in the resin-impregnated base material 2, the liquid crystal polyester as the resin with which the inorganic fiber or the carbon fiber is impregnated was described in First and Second Embodiments, a resin other than the liquid crystal polyester (for example, thermosetting resins such as polyimide and epoxy resins) can also be substituted for the liquid crystal polyester or used in combination with the liquid crystal polyester.

The case where the shape of each of the resin-impregnated base material 2, the copper foil 3, the spacer copper foil 5, the SUS plate 10, the SUS plate 6 and the aramid cushion 7 is a square plate shape or a square sheet shape was described in First and Second Embodiments. However, the shape of each of the members is not limited to a square plate shape or a square sheet shape and may be, for example, a rectangular plate shape or a rectangular sheet shape.

The case of producing the first laminate 8 in which the resin-impregnated base material 2 is sequentially interposed between a pair of copper foils 3A, 3B and between a pair of spacer copper foils 5A, 5B, in the first laminate production process was described in First and Second Embodiments. However, the first laminate 8 may be fabricated by only interposing the resin-impregnated base material 2 between the pair of copper foils 3A, 3B, omitting the pair of spacer copper foils 5A, 5B.

The case of producing the second laminate 9 in which the first laminate 8 is sequentially interposed between a pair of SUS plates 10A, 10B, between a pair of SUS plates 6A, 6B and between a pair of aramid cushions 7A, 7B, in the second laminate production process was described in First and Second Embodiments. However, the second laminate 9 may be fabricated by only interposing the first laminate 8 between the pair of SUS plates 10A, 10B, omitting the pair of SUS plates 6A, 6B and the pair of aramid cushions 7A, 7B.

While the three-stage configuration was described in Second Embodiment, it is also possible to generally adopt a multi-stage configuration (for example, two-stage configuration, five-stage configuration, etc.).

### EXAMPLES

Examples of the present invention will be described below. The present invention is not limited to Examples.

### <Fabrication of Resin-Impregnated Base Material>

In a reactor equipped with a stirrer, a torque meter, a nitrogen gas introducing tube, a thermometer and a reflux condenser, 1,976 g (10.5 mol) of 2-hydroxy-6-naphthoic acid, 1,474 g (9.75 mol) of 4-hydroxyacetoanilide, 1,620 g (9.75 mol) of isophthalic acid and 2,374 g (23.25 mol) of acetic anhydride were charged. After sufficiently replacing the atmosphere in the reactor with a nitrogen gas, the temperature was raised to 150° C. over 15 minutes under a nitrogen gas flow and the mixture was refluxed for 3 hours by maintaining at the temperature (150° C.).

Thereafter, the temperature was raised to 300° C. over 170 minutes while distilling off acetic acid and unreacted acetic anhydride distilled as by-products. The point of time at which an increase in torque was recognized was regarded as the point of time at which the reaction had been completed, and then contents were taken out. The contents were cooled to room temperature and ground by a grinder to obtain a powder of a liquid crystal polyester having comparatively low molecular weight. The flow initiation temperature of the powder thus obtained was measured by a flow tester (“Model CFT-500”, manufactured by Shimadzu Corporation) and found to be 235° C. Solid phase polymerization was carried out by subjecting this liquid crystal polyester powder to a heat treatment under a nitrogen atmosphere at 223° C. for 3 hours. The flow initiation temperature of the liquid crystal polyester after solid phase polymerization was 270° C.

The liquid crystal polyester thus obtained (2,200 g) was added to 7,800 g of N,N-dimethylacetamide (DMAc), followed by heating at 100° C. for 2 hours to obtain a liquid composition. The solution viscosity of this liquid composition was 320 cP. The melt viscosity is a value measured at a measuring temperature of 23° C. using a B type viscometer “Model TVL-20” (rotor No. 21; rotary rate: 5 rpm), manufactured by Toki Sangyo Co., Ltd.

A glass cloth (glass cloth measuring 45 μm in thickness, IPC name of 1078, manufactured by Arisawa Manufacturing Co., Ltd.) was impregnated with the liquid composition thus obtained to fabricate a resin-impregnated base material and this resin-impregnated base material was dried by a hot-air type dryer set at a temperature of 130° C. and then subjected to a heat treatment under a nitrogen atmosphere at 290° C. for 3 hours, thereby increasing the molecular weight of the liquid crystal polyester in the resin-impregnated base material. As a result, a heat-treated resin-impregnated base material was obtained.

### Example 1

Using the aforementioned heat-treated resin-impregnated base material, an aramid cushion (aramid cushion measuring 3 mm in thickness, 520 mm in length and 520 mm in width, manufactured by Ichikawa Techno-Fabrics Co., Ltd.), a SUS plate (SUS304, measuring 5 mm in thickness, 500 mm in length and 500 mm in width), a SUS plate (SUS304, measuring 1 mm in thickness, 500 mm in length and 500 mm in width), a spacer copper foil (“3EC-VLP” measuring 18 μm in thickness, manufactured by MITSUI MINING & SMELTING CO., LTD.), a copper foil constituting a metal foil laminate (“3EC-VLP” measuring 18 μm in thickness, 453 mm in length and 453 mm in width, manufactured by MITSUI MINING & SMELTING CO., LTD.), a resin-impregnated base material constituting a metal foil laminate (prepreg measuring 7 μm in thickness, 433 mm in length and 433 mm in width in which a glass cloth is impregnated with a liquid crystal polyester), a copper foil constituting a metal foil laminate (“3EC-VLP” measuring 18 μm in thickness, 453 mm in length and 453 mm in width, manufactured by MITSUI MINING & SMELTING CO., LTD.), a spacer copper foil (“3EC-VLP” measuring 18 μm in thickness, manufactured by MITSUI MINING & SMELTING CO., LTD.), a SUS plate (SUS304, measuring 1 mm in thickness, 500 mm in length and 500 mm in width), a SUS plate (SUS304, measuring 5 mm in thickness, 500 mm in length and 500 mm in width) and an aramid cushion (aramid cushion measuring 3 mm in thickness, 520 mm in length and 520 mm in width, manufactured by Ichikawa Techno-Fabrics Co., Ltd.) were sequentially lamination from the bottom. Using a high temperature vacuum press machine (“KVHC-PRESS” measuring 300 mm in length and 300 mm in width, manufactured by KITAGAWA SEIKI Co., Ltd.), this second laminate was integrated by hot pressing for 30 minutes under the conditions of a temperature of 340° C. and a pressure (specific pressure to a resin-impregnated base material) of 5 MPa to obtain a metal foil laminate.

### Example 2

In the same manner as in Example 1, except that the size of the resin-impregnated base material was set at 480 mm square (480 mm in length, 480 mm in width) and also the size of the copper foil was set at 500 mm square (500 mm in length, 500 mm in width) according to the size of the resin-impregnated base material, a metal foil laminate was produced. In this metal foil laminate, the ratio of an area of the copper foil to that of the SUS plate became 0.92.

### Comparative Example 1

In the same manner as in Example 1, except that the size of the resin-impregnated base material was set at 250 mm square (250 mm in length, 250 mm in width) and also the size of the copper foil was set at 270 mm square (270 mm in length, 270 mm in width) according to the size of the resin-impregnated base material, a metal foil laminate was produced. In this metal foil laminate, the ratio of an area of the copper foil to that of the SUS plate became 0.25.

### Comparative Example 2

In the same manner as in Example 1, except that the size of the resin-impregnated base material was set at 353 mm square (353 mm in length, 353 mm in width) and also the size of the copper foil was set at 373 mm square (373 mm in length, 373 mm in width) according to the size of the resin-impregnated base material, a metal foil laminate was produced. In this metal foil laminate, the ratio of an area of the copper foil to that of the SUS plate became 0.5.

### <Evaluation of Adhesion of Metal Foil Laminate>

With respect to Example 1, Example 2 and Comparative Example 1 and Comparative Example 2, a peel strength (unit N/cm) of the metal foil laminates was respectively measured so as to evaluate tight adhesion of the metal foil laminates. That is, each of the metal foil laminates was cut into a strip shape measuring 10 mm in length to fabricate ten specimens. With respect each specimen, a peel strength (90° peel strength) of the metal foil laminate was measured by peeling a copper foil from a resin-impregnated base material at a peel rate of 50 mm/minute in the direction at an angle of 90° in a state where the resin-impregnated base material was fixed, and then the average of ten specimens was calculated. The results are summarized in Table 1.

TABLE 1

| | Comparative | Comparative | Example | Example |
|---|---|---|---|---|
| | Example 1 | Example 2 | 1 | 2 |
| Size of resin- | 250 mm | 353 mm | 433 mm | 480 mm |
| impregnated base | square | square | square | square |
| material | | | | |
| Size of copper foil | 270 mm | 373 mm | 453 mm | 500 mm |
| | square | square | square | square |
| Ratio of area of | 0.25 | 0.5 | 0.75 | 0.92 |
| resin-impregnated | | | | |
| base material to | | | | |
| area of SUS plate | | | | |
| Peel strength | 7.3 | 9.4 | 10.1 | 11.3 |
| (average) [N/cm] | | | | |

As is apparent from Table 1, in Comparative Examples 1, 2, since the ratios of an area of a copper foil to a SUS plate were small, such as 0.25 and 0.5, respectively, peel strengths were 7.3 N/cm and 9.4 N/cm at most. In contrast, in Examples 1, 2, since the ratios of an area of a copper foil to a SUS plate were large, such as 0.75 and 0.92, respectively, peel strengths were increased to 10.1 N/cm and 11.3 N/cm.

The present invention is suited for the production of a metal foil laminate, particularly most of metal foil laminates, used as a material for a printed circuit board.

What is claimed is:

1. A method for producing a metal foil laminate, the method comprising sequentially interposing an insulating base material between a pair of metal foils and between a pair of metal plates, followed by heating and pressurizing to produce a metal foil laminate in which the pair of metal foils are attached on both sides of the insulating base material, wherein the ratio of an area of the insulating base material to that of each metal plate is from 0.75 to 0.95.

2. The method for producing a metal foil laminate according to claim 1, wherein the insulating base material is a prepreg in which an inorganic fiber or a carbon fiber is impregnated with a thermoplastic resin.

3. The method for producing a metal foil laminate according to claim 2, wherein the thermoplastic resin is a liquid crystal polyester having a flow initiation temperature of 250° C. or higher.

4. The method for producing a metal foil laminate according to claim 3, using, as the liquid crystal polyester, a liquid crystal polyester including structural units represented by the formulas (1), (2) and (3) shown below, wherein the content of the structural unit represented by the formula (1) is from 30 to 45 mol %, the content of the structural unit represented by the formula (2) is from 27.5 to 35 mol %, and the content of the structural unit represented by the formula (3) is from 27.5 to 35 mol %, based on the total content of all structural units:
—O—Ar¹—CO—, (1)
—CO—Ar²—CO—, (2)
—X—Ar³—Y— (3)
wherein Ar¹ represents a phenylene group or a naphthylene group, Ar² represents a phenylene group, a naphthylene group or a group represented by the formula (4) shown below, Ar³ represents a phenylene group or a group represented by the formula (4) shown below, X and Y each independently represent O or NH, and hydrogen atoms, existing in the group represented by Ar', Ar² or Ar³, each independently may be substituted with a halogen atom, an alkyl group or an aryl group, and
—Ar¹¹—Z—Ar¹² (4)
wherein Ar¹¹ and Ar¹² each independently represent a phenylene group or a naphthylene group, and Z represents O, CO or SO₂.

5. The method for producing a metal foil laminate according to claim 4, wherein at least one of X and Y of the structural unit represented by the formula (3) is NH.
